(19) United States
(12) Patent Application Publication
(10) Pub. No.: US 2016/0326024 A1
(43) Pub. Date: Nov. 10, 2016

(54) WATER DISINFECTION APPARATUS AND METHOD FOR DISINFECTION OF RECIRCULATED WATER IN A COOLING TOWER

(71) Applicant: EMO3 INC., Montreal (CA)

(72) Inventor: Dave GILBERT, Quebec (CA)

(21) Appl. No.: 14/707,784

(22) Filed: May 8, 2015

(51) Int. Cl. C02F 1/467; C02F 1/461

(52) U.S. Cl. CPC C02F 1/467; C02F 1/46104; C02F 2303/04; C02F 2201/461; C02F 2201/46155; C02F 2209/04

(57) ABSTRACT

A water cooling system has a cooling tower, a first conduit for supplying water from the cooling tower to at least one device to be cooled, and a second conduit fluidly connected to the cooling tower. A water disinfection apparatus has an electrolysis apparatus having an inlet an inlet fluidly connected to the second conduit and an outlet fluidly connected to the cooling tower, a conductivity sensor sensing a conductivity of water in the first conduit, an oxidation-reduction potential (ORP) sensor sensing an ORP level of water in the second conduit; and a power supply connected to the electrolysis apparatus. The power supply powers the electrolysis apparatus when: the conductivity of water in the first conduit is a least 1500 microsiemens; and the ORP level of water in the second conduit is less than a predetermined value. A method for disinfecting recirculated water of a cooling tower is also disclosed.

### FIELD OF TECHNOLOGY

The present technology relates to a water disinfection apparatus and method for disinfection of recirculated water in a cooling tower.

### BACKGROUND

Water-based cooling towers are used in heating, ventilating, and air conditioning (HVAC) systems to remove excess heat from mechanical devices such as chillers and compressors. The evaporation of water within a cooling tower provides a very effective and efficient means in transferring the heat load contained within the HVAC system to the air.

The recirculated water absorbs the undesired heat at the chiller or the process load by thermal conduction. This water is then piped through the cooling tower water circuit until it reaches the cooling tower.

The recirculated water is then distributed uniformly throughout the cooling tower. The water is sprayed by droplets over the louvers and dampers contained in the cooling tower. During this time, an opposite forced air flow is maintained and comes in contact with the water droplets. The air flow accelerates the evaporation process when in contact with the water. This process enables the absorbed heat in the water to be removed which is equivalent to the latent heat of vaporization.

The loss of recirculated water within a cooling tower circuit must be replaced with the addition of the equivalent amount of evaporated water. Typically municipal water is used to replenish the evaporated water. This is referred to make-up water and contains suspended solids. The evaporated water does not contain suspended solids. As more water is evaporated, this leads to a concentration of dissolved and suspended solids in the recirculated water since these solids can not be evaporated. Furthermore, since the concentration of suspended solids increases over time due to evaporation, the recirculated water needs to be purged to lower the concentration of suspended solids. This is referred to as blow-down. The blow-down contains concentrated suspended solids. The term that designates the relationship between the evaporation of recirculated water, the blow-down of water and the replenishment of new water is referred to as cycles-of-concentration. The following relationships exist:

Make-up Water=Evaporation of Recirculated Water+Blow-Down

Cycles of Concentration=Evaporation/Blow-Down+1

A means to measure the concentration of suspended solids is to measure the conductivity of the recirculated water. Since the suspended solids contains a higher level of dissolved salts notably calcium carbonate (CaCo3), this leads to a higher level of electrical conductivity in the recirculated water. There is a correlation between total dissolved solids and the electrical conductivity in the recirculated water. In general, cooling tower operators limit the concentration of water to a reading of 1,100 microsiemens. This generally equates to a cycle of concentration between 3 and 5. The concentration of water is dependent on the hardness of the municipal make-up water. In general, this represents a problem in terms of environment and cost, since the blow-down water being discharged to the municipal water contains undesirable chemical additives. This is documented in United States Patent Publication No. US 2011/0120885 A1, published May 26, 2011.

Typically within the open-loop water-based cooling tower systems, the recirculated water comes into contact with external air and sometimes collects debris, dust and foreign particles that may contain source for bacteria growth. In addition, the water temperature variations within water-based cooling systems range from 23.9° C. to 35° C. (75° F. to 95° F.) which is an ideal temperature for proliferation of bacterial growth, notably Legionella pneumophilia which can lead to Legionnaires' disease (legionellosis or Legion fever). Moreover, excess bacterial growth leads to bio-fouling within the water circuit as well as in the mechanical devices such as the thermal exchange plates within the chillers. This leads to decreased efficiency since the biofilm acts a barrier to thermal transfer.

As such, cooling tower operators need to treat the water to maximize efficiency, safety and prolong the life-cycle of the mechanical devices comprising the HVAC system. Amongst different water treatment, organic control by biocide treatment is of utmost importance.

Organic treatment may be controlled by dosing sufficient oxidant and non-oxidant based biocides directly in the water circuit of the cooling towers. By properly dosing the biocides based on the water cycles of concentration, temperature and bacterial count, adequate control may be achieved.

In general, periodic biocide dosing represents several problems most notably the recurring manual adjustment of the biocides depending on the evaporation of the recirculated water as well as the heat load on the mechanical systems. Furthermore, human error in water analysis can provide inadequate biocide dosing. Moreover, continuous monitoring of biocide inventory levels must be made by cooling tower owners to ensure adequate supply of biocide dosing. All too often, inspection routines are either omitted or forgotten leading towards stock-out of biocides. This omission problem causes bacterial and biofilm growth in the recirculated water of the cooling tower circuit which can lead to serious health issues as well as mechanical problems.

Therefore, there is a desire for a water disinfection apparatus and method for disinfection of recirculated water in a cooling tower.

### SUMMARY

One object of the present technology is to ameliorate at least some of the inconveniences of the prior art.

In light of the above problems, an alternative to chemically based biocide treatment is available, notably ozone-based solutions. Ozone production has the particular advantage of being extremely rapid and reacts 3000 times faster than chlorine. As little as 0.3 mg/L of ozone in water for 5 minutes provides a 99% kill rate of Legionella pneumophila.

According to one aspect of the present technology, there is provided a water disinfection apparatus for disinfection of recirculated water in a water cooling system. The water cooling system has a cooling tower, a first conduit fluidly connected to the cooling tower, the first conduit being adapted for supplying water from the cooling tower to at least one device to be cooled, and a second conduit fluidly connected to the cooling tower, the second conduit supplying water from the cooling tower to the water disinfection apparatus. The water disinfection apparatus has an electrolysis apparatus having an inlet and an outlet, the inlet being adapted for fluidly connecting to the second conduit to receive water from the second conduit and the outlet being adapted for fluidly connecting to the cooling tower for supplying water to the cooling tower, a conductivity sensor adapted to sense a conductivity of water in the first conduit, an oxidation-reduction potential (ORP) sensor adapted to sense an ORP level of water in the second conduit, and a power supply electrically connected to the electrolysis apparatus for selectively powering the electrolysis apparatus. The power supply powers the electrolysis apparatus when: the conductivity of water in the first conduit sensed by the conductivity sensor is a least 1500 microsiemens; and the ORP level of water in the second conduit sensed by the ORP sensor is less than a predetermined value.

In some embodiments of the present technology, the predetermined value is 450 mV.

In some embodiments of the present technology, a controller is connected to the power supply, the conductivity sensor and the ORP sensor. The controller sends a signal to the power supply to cause the power supply to power the electrolysis apparatus when: the conductivity of water in the first conduit sensed by the conductivity sensor is a least 1500 microsiemens; and the ORP level of water in the second conduit sensed by the ORP sensor is less than a predetermined value.

In some embodiments of the present technology, the electrolysis apparatus is an electrolytic cell having at least one anode and at least one cathode disposed parallel to a flow of water in the electrolysis apparatus.

In some embodiments of the present technology, the electrolysis apparatus uses water supplied by the second conduit as an electrolytic medium.

In some embodiments of the present technology, the power supply supplies power to the electrolysis apparatus at a direct current voltage of at least 48 volts and a current of at least 5 amps.

In some embodiments of the present technology, the ORP sensor is disposed upstream of the electrolysis apparatus.

According to another aspect of the present technology, there is provided a system having a water cooling system and a water disinfection apparatus for disinfection of recirculated water in the water cooling system. The system has a cooling tower; a first conduit fluidly connected to the cooling tower, the first conduit being adapted for supplying water from the cooling tower to at least one device to be cooled; a second conduit fluidly connected to the cooling tower; an electrolysis apparatus having an inlet and an outlet, the inlet being fluidly connected to the second conduit to receive water from the second conduit and the outlet being fluidly connected to the cooling tower for supplying water to the cooling tower; a conductivity sensor sensing a conductivity of water in the first conduit; an oxidation-reduction potential (ORP) sensor sensing an ORP level of water in the second conduit; and a power supply electrically connected to the electrolysis apparatus for selectively powering the electrolysis apparatus. The power supply powering the electrolysis apparatus when: the conductivity of water in the first conduit sensed by the conductivity sensor is a least 1500 microsiemens; and the ORP level of water in the second conduit sensed by the ORP sensor is less than a predetermined value.

In some embodiments of the present technology, the predetermined value is 450mV.

In some embodiments of the present technology, a controller connected to the power supply, the conductivity sensor and the ORP sensor. The controller sends a signal to the power supply to cause the power supply to power the electrolysis apparatus when: the conductivity of water in the first conduit sensed by the conductivity sensor is a least 1500 microsiemens; and the ORP level of water in the second conduit sensed by the ORP sensor is less than a predetermined value.

In some embodiments of the present technology, the electrolysis apparatus is an electrolytic cell having at least one anode and at least one cathode disposed parallel to a flow of water in the electrolysis apparatus.

In some embodiments of the present technology, the electrolysis apparatus uses water supplied by the second conduit as an electrolytic medium.

In some embodiments of the present technology, the power supply supplies power to the electrolysis apparatus at a direct current voltage of at least 48 volts and a current of at least 5 amps.

In some embodiments of the present technology, the ORP sensor is disposed upstream of the electrolysis apparatus.

In some embodiments of the present technology, an inlet of the second conduit is connected to the first conduit such that water from the cooling tower is supplied to the second conduit via the first conduit.

In some embodiments of the present technology, there is provided a method for disinfecting recirculated water of a cooling tower comprising: determining a conductivity of the recirculated water using a conductivity sensor; determining an oxidation-reduction potential (ORP) level of the recirculated water using an ORP sensor; electrolyzing at least a portion of the recirculated water when the conductivity of the recirculated water is at least 1500 microsiemens and the ORP level of the recirculated water is less than a predetermined value.

In some embodiments of the present technology, the predetermined value is 450 mV.

In some embodiments of the present technology, the method further comprises increasing the conductivity of the recirculated water when the conductivity of the recirculated water is at least 1500 microsiemens by at least one of: evaporation of water in the cooling tower; and addition of electrolytic solution in the recirculated water.

In some embodiments of the present technology, the method further comprises stopping the electrolyzing of at least the portion of the recirculated water when the ORP level of the recirculated water is at or is greater than the predetermined value.

In some embodiments of the present technology, the recirculated water is the electrolytic medium used for electrolyzing.

Embodiments of the present technology each have at least one of the above-mentioned aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE FIGURES

For a better understanding of the present technology, as well as other aspects and further features thereof, reference is made to the following description which is to be used in conjunction with the accompanying drawings, where:

FIG. 1 is a schematic illustration of a water cooling system and water disinfection apparatus ; and

FIG. 2 is flow chart illustrating a method of controlling the water disinfection apparatus of FIG. 1.

### DETAILED DESCRIPTION

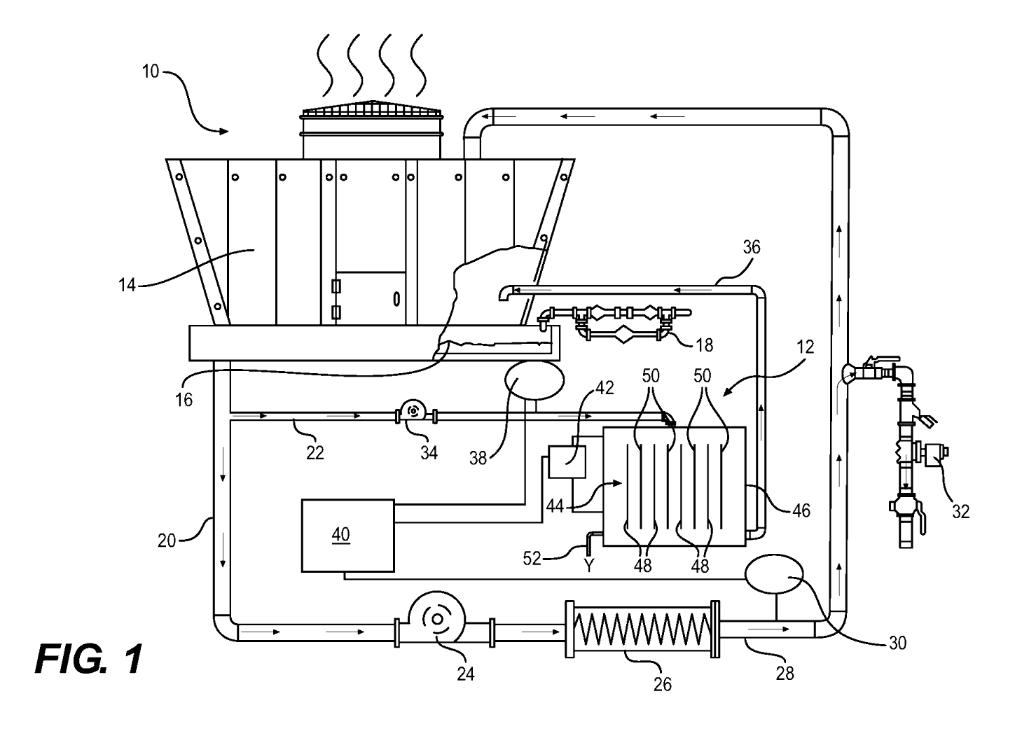

A water cooling system 10 and water disinfection apparatus 12 in accordance with the present technology are shown in FIG. 1. The system 10 has a cooling tower 14 which incorporates a plurality of piping, louvers, vents, spray nozzles and forced air ventilation for the purpose of dissipating latent heat absorbed through the recirculated main water. The dissipated latent heat is provided by evaporation. The cooling tower 14 contains a water basin 16 that collects the cooled water. Within the water basin 16 there is a level indicator (not shown) that provides an indication that replenishment of water in the basin 16 due to the loss of water via evaporation is required. The replenishment of water is identified and provided by a make-up water system 18. The make-up water is typically supplied by the municipal water source. Additional details regarding the cooling tower 14 are not provided herein as they are believed to be generally understood in the art.

The water contained in the water basin 16 is then circulated through a main conduit 20 connected to the basin 16 toward mechanical devices (not shown) that need to be cooled. It is contemplated that more than one main conduit 20 could be connected to the water basin 16. A side-stream or portion of the water flowing in the main conduit 20 is derived toward a secondary conduit 22 in order to be supplied to the water disinfection apparatus 12 for disinfection as will be described in greater detail below.

The main water circulates through the main conduit 20 by forced action of a recirculation pump 24. From the pump 24, the main water circulates through a heat process load transfer or condenser 26. Through conductive means, the heat load from the mechanical systems is transferred to the main water. This main water continues its path in a conduit 28. An in-line conductivity sensor 30 measures the conductivity of the main water in the conduit 28 to determine the blow-down requirements in order to lower the concentration of dissolved solids contained in the main water. If the concentration of dissolved solids is too high, a portion of the main water is purged via a purge system 32 until the conductivity measurement is acceptable to the cooling tower operator's parameters.

The main water continues its course in the conduit 28 and is supplied near or at the upper portion of the cooling tower 14 in order to dissipate the acquired heat. This process is repeated during the operation of the water cooling system 10.

The main water circulates through secondary conduit 22 by forced action of a pump 34. It is contemplated that the pump 34 could be omitted. It is also contemplated that more than one secondary conduit 22 could be provided. It is also contemplated that the inlet of the secondary conduit 22 could be connected at a location other than the one shown in FIG. 1 in order to receive the main water. For example, it is contemplated that the inlet of the secondary conduit 22 could be connected directly to the water basin 16, to the pump 24, between the pump 24 and the condenser 26, to the condenser 26 or to the conduit 28. As mentioned above, water in the secondary conduit 22 the flows to the water disinfection apparatus 12. From the water disinfection apparatus 12, the water is returned to the water basin 16 of the cooling tower 14 via conduit 36. It is contemplated that the water conduit 36 could return the water anywhere downstream of the inlet of the secondary conduit 22 in the water cooling system 10. For example, it is contemplated that the outlet of the conduit 36 could be connected to the main conduit 20, to the pump 24, between the pump 24 and the condenser 26, to the condenser 26 or to the conduit 28.

The water disinfection apparatus 12 will now be described. The water disinfection apparatus 12 includes the above-mentioned in-line conductivity sensor 30, an oxidation-reduction potential (ORP) sensor 38, a controller 40, a power supply 42 and an electrolysis apparatus 44.

The in-line conductivity sensor 30 is connected to the controller 40 and provides signals representative of the conductivity of the water in the conduit 28 to the controller.

The power supply 42 is connected to the electrolysis apparatus 44 and provides the electrical supply necessary to actuate the electrolysis. The power supply 42 is connected to the controller 40 which turns it on or off as described below. The power supply 42 includes an AC-DC converter that converts alternating current voltage of 120 volts into direct current voltage of 48 volts. Other voltage conversions are also contemplated. For example, the power supply 42 could convert alternating current voltage of 240 volts into direct current voltage of 54 volts. Other voltages are also contemplated depending on the characteristics of the electrolysis apparatus 44. It is also contemplated that the power supply 42 could include a DC-DC converter should the power supply 42 be itself be supplied with direct current voltage. It is also contemplated that the power supply 42 could not include a converter. In the present embodiment, the power supply 42 supplies at least 5 amps of current to the electrolysis apparatus 44. It is contemplated that the current provided by the power supply 42 could be in the range of 5 to 20 amps. It is also contemplated that the current could be less than 5 amps or more than 20 amps depending on the characteristics of the electrolysis apparatus 44. The power supply 42 is connected to the controller 40 in order to receive signals from the controller 40. It is contemplated that the connection between the controller 40 and the power supply 42 could be a wired or a wireless connection.

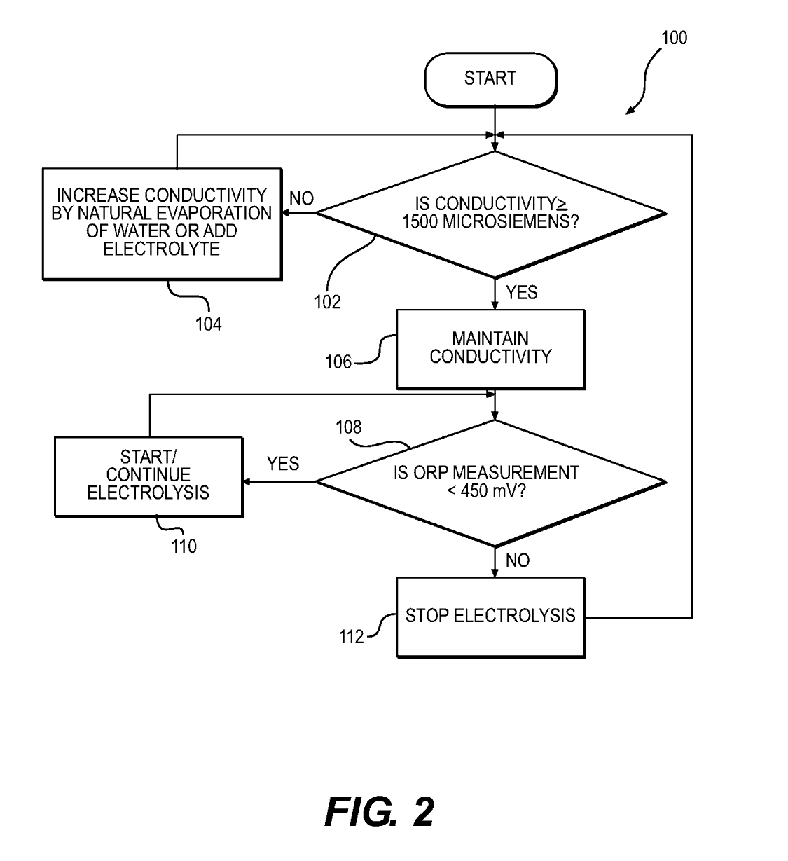

The main water circulates in secondary conduit 22 to the inlet of the electrolysis apparatus 44. Before reaching the electrolysis apparatus 44, the water in the secondary conduit 22 passes through the ORP sensor 38 which measures the capacity of the oxidative ability of the water to destroy contaminants contained in the water. The details regarding the oxidative ability of the water are not are not provided herein as they are believed to be generally well understood in the art. The higher the ORP measurement, the higher the capacity of water to destroy the contaminants. The ORP sensor 38 continuously reads the ORP level in the main water and sends signals representative of the ORP level to the controller 40. It is contemplated that the ORP sensor 38 could read the ORP level in the main water intermittently. Based on the ORP level readings provided by the ORP sensor 38, the controller 40 turns the power supply 42 on or off by comparing the ORP level readings to predetermined ORP values set in the controller 40 as will be described below with respect to FIG. 2. It is contemplated that the controller 40 could be omitted and that the ORP sensor 38 could be connected to the power supply 42 to turn the power supply 42 on or off based on predetermined ORP values set in the ORP sensor 38.

In the present embodiment, the electrolysis apparatus 44 is an electrolytic cell having a chamber 46 that contains several anodes 48 and several cathodes 50 connected to the power supply 40. In one embodiment, the anodes 48 and cathodes 50 are disposed parallel to a flow of water through the chamber 46. It is contemplated that the chamber 46 could contain only one anode 48 and one cathode 50. In one embodiment, the anodes 48 and the cathodes 50 have a platinum coating. A drain 52 is provided at the bottom of the chamber 46 in order to permit water in the chamber 46 to be drained when maintenance of the electrolysis apparatus 44 is required for example.

The main water circulates under forced pressure through the chamber 46 between the anodes 48 and the cathodes 50. The anodes and cathodes are electrically charged by the direct current voltage supplied by the power supply 42. Since the dissolved solids in the main water have been concentrated by the evaporation occurring in the cooling tower 14, the conductive nature of the main water provides a suitable medium for electrolytic conversion of the minerals contained in the water into oxidants notably ozone and hydrogen peroxide for water disinfection. The electrolysis apparatus 44 uses the water as an electrolytic medium and creates a combination of oxidation compounds amongst other oxidants with the following reaction:

3H₂O→O₃+6H⁺+6e⁻ a.

2H₂O→O₂+4H⁺+4e⁻ b.

O₂+2H⁺+2e⁻→H₂O₂ c.

Additionally, acid based chemical products injected in the main water may increase the conductivity of the main water and assist in creating additional oxidants in the water such as chlorine which is a beneficial factor for water disinfection.

Additionally, it has been discovered that increasing the cycles of concentration of the main water greater than 1,500 microsiemens enhances the electrolytic performance, thus providing greater oxidative components for water disinfection. This also has a beneficial environmental effect since there is less discharge of the main water and thus less make-up water is required.

Furthermore, it has been discovered that the addition of small doses of an electrolytic solution(s), such as salt brine (NaCl) and/or sodium hypochlorite (NaOCl), in the main water greatly increased the conductivity as well as the oxidant production in the electrolysis apparatus 44 for disinfection. In one embodiment, the doses of electrolytic solution(s) are less than 10 ml per 1000 ml of water. This is due to the separation of the sodium hypochlorite into chlorine and sodium salts. Accordingly, it is contemplated that sodium hypochlorite could as an additive for the gained performance of oxidant production in the recirculated water.

From the outlet of the electrolysis apparatus 44, the water, which is now mixed with the oxidants generated by the electrolysis process, is returned to the water basin 16 of the water tower 14 via the conduit 36. The oxidants disinfect the water in the water basin 16 and the water running through the rest of the water cooling system 10.

Turning now to FIG. 2 the method 100 of controlling the water disinfection apparatus 12 will be described. This control method 100 is implemented in the controller 40. The controller 40 can be a programmable logic controller or an equivalent device. Although a single controller 40 is illustrated, it is contemplated that the functions of the controller 40 could be separated between multiple controllers.

The method 100 begins at step 102 with the analysis of the conductivity of the recirculated water in the conduit 28 by the conductivity sensor 30. If, based on the signals received from the conductivity sensor 30, the controller 40 determines that the level of conductivity is below 1,500 microsiemens, the controller 40 proceeds to step 104. At step 104, the conductivity of the water is increased by natural evaporation of the recirculated water in the cooling tower 14, in which case the method 100 is on hold until enough water has evaporated, and/or by the addition of electrolytic solution. It is contemplated that the addition of electrolytic solution could be done by having the controller 40 operate an automatic electrolytic solution or by sending a signal, on a control panel for example, to an operator of the cooling system 10 that electrolytic solution is to be added.

If at step 102, the recirculated water has a conductivity greater than 1,500 microsiemens, then this conductivity is maintained (step 106) and then the ORP of the recirculated water is obtained from the in-line ORP sensor 38.

If at step 108, based on the signals received from the ORP sensor 38, the controller 40 determines that the ORP reading is below 450 mV (millivolts), then at step 110 the electrolysis apparatus 44 carries out the electrolysis process to generate oxidants as described above. If at step 110 the power supply 42 is not already powering the electrolysis apparatus 44, then the controller 40 sends a signal to the power supply 42 to turn on such that the electrolysis process can be carried out. It is contemplated that the controller 40 could send signals to the power supply 42 to control the amount of power being supplied to the electrolysis apparatus 44 during step 110.

If at step 108, based on the signals received from the ORP sensor 38, the controller 40 determines that the ORP reading is at or above 450 mV, then at step 112 the controller 40 sends a signal to the power supply 42 to turn off, if it is not already turned off, such that the electrolysis process stops, and the method 100 returns to step 102. In the present embodiment, it has been determined that once the level of oxidants for the disinfection of water in the recirculated water has reached an ORP reading of 450 mV that there is a sufficient level of oxidants in the water. It is contemplated that other values of ORP level could be used to make the determination at step 108. It is also contemplated at step 112, the controller 40 could also send a signal to turn off the pump 34 and/or close a valve (not shown) to prevent water to flow in conduit 22, in which case the controller 40 would also send a signal to turn on the pump 34 and/or open the valve when initiating step 110.

In the present embodiment, this method 100 is conducted continuously during operation of the water cooling system 10.

Modifications and improvements to the above-described implementations of the present may become apparent to those skilled in the art. The foregoing description is intended to be exemplary rather than limiting. The scope of the present is therefore intended to be limited solely by the scope of the appended claims.

What is claimed is:

1. A water disinfection apparatus for disinfection of recirculated water in a water cooling system, the water cooling system comprising:
a cooling tower;
a first conduit fluidly connected to the cooling tower, the first conduit being adapted for supplying water from the cooling tower to at least one device to be cooled; and
a second conduit fluidly connected to the cooling tower, the second conduit supplying water from the cooling tower to the water disinfection apparatus;
the water disinfection apparatus comprising:
an electrolysis apparatus having an inlet and an outlet, the inlet being adapted for fluidly connecting to the second conduit to receive water from the second conduit and the outlet being adapted for fluidly connecting to the cooling tower for supplying water to the cooling tower;
a conductivity sensor adapted to sense a conductivity of water in the first conduit;
an oxidation-reduction potential (ORP) sensor adapted to sense an ORP level of water in the second conduit; and
a power supply electrically connected to the electrolysis apparatus for selectively powering the electrolysis apparatus, the power supply powering the electrolysis apparatus when:
the conductivity of water in the first conduit sensed by the conductivity sensor is a least 1500 microsiemens; and
the ORP level of water in the second conduit sensed by the ORP sensor is less than a predetermined value.

2. The water disinfection apparatus of claim 1, wherein the predetermined value is 450 mV.

3. The water disinfection apparatus of claim 1, further comprising a controller connected to the power supply, the conductivity sensor and the ORP sensor;
wherein the controller sends a signal to the power supply to cause the power supply to power the electrolysis apparatus when:
the conductivity of water in the first conduit sensed by the conductivity sensor is a least 1500 microsiemens; and
the ORP level of water in the second conduit sensed by the ORP sensor is less than a predetermined value.

4. The water disinfection apparatus of claim 1, wherein the electrolysis apparatus is an electrolytic cell having at least one anode and at least one cathode disposed parallel to a flow of water in the electrolysis apparatus.

5. The water disinfection apparatus of claim 1, wherein the electrolysis apparatus uses water supplied by the second conduit as an electrolytic medium.

6. The water disinfection apparatus of claim 1, wherein the power supply supplies power to the electrolysis apparatus at a direct current voltage of at least 48 volts and a current of at least 5 amps.

7. The water disinfection apparatus of claim 1, wherein the ORP sensor is disposed upstream of the electrolysis apparatus.

8. A system having a water cooling system and a water disinfection apparatus for disinfection of recirculated water in the water cooling system, the system comprising:
a cooling tower;
a first conduit fluidly connected to the cooling tower, the first conduit being adapted for supplying water from the cooling tower to at least one device to be cooled;
a second conduit fluidly connected to the cooling tower;
an electrolysis apparatus having an inlet and an outlet, the inlet being fluidly connected to the second conduit to receive water from the second conduit and the outlet being fluidly connected to the cooling tower for supplying water to the cooling tower;
a conductivity sensor sensing a conductivity of water in the first conduit;
an oxidation-reduction potential (ORP) sensor sensing an ORP level of water in the second conduit; and
a power supply electrically connected to the electrolysis apparatus for selectively powering the electrolysis apparatus, the power supply powering the electrolysis apparatus when:
the conductivity of water in the first conduit sensed by the conductivity sensor is a least 1500 microsiemens; and
the ORP level of water in the second conduit sensed by the ORP sensor is less than a predetermined value.

9. The system of claim 8, wherein the predetermined value is 450 mV.

10. The system of claim 8, further comprising a controller connected to the power supply, the conductivity sensor and the ORP sensor;
wherein the controller sends a signal to the power supply to cause the power supply to power the electrolysis apparatus when:
the conductivity of water in the first conduit sensed by the conductivity sensor is a least 1500 microsiemens; and
the ORP level of water in the second conduit sensed by the ORP sensor is less than a predetermined value.

11. The system of claim 8, wherein the electrolysis apparatus is an electrolytic cell having at least one anode and at least one cathode disposed parallel to a flow of water in the electrolysis apparatus.

12. The system of claim 8, wherein the electrolysis apparatus uses water supplied by the second conduit as an electrolytic medium.

13. The system of claim 8, wherein the power supply supplies power to the electrolysis apparatus at a direct current voltage of at least 48 volts and a current of at least 5 amps.

14. The system of claim 8, wherein the ORP sensor is disposed upstream of the electrolysis apparatus.

15. The system of claim 8, wherein an inlet of the second conduit is connected to the first conduit such that water from the cooling tower is supplied to the second conduit via the first conduit.

16. A method for disinfecting recirculated water of a cooling tower comprising:
determining a conductivity of the recirculated water using a conductivity sensor;
determining an oxidation-reduction potential (ORP) level of the recirculated water using an ORP sensor;
electrolyzing at least a portion of the recirculated water when the conductivity of the recirculated water is at least 1500 microsiemens and the ORP level of the recirculated water is less than a predetermined value.

17. The method of claim 16, wherein the predetermined value is 450 mV.

18. The method of claim 16, further comprising increasing the conductivity of the recirculated water when the conductivity of the recirculated water is at least 1500 microsiemens by at least one of:
evaporation of water in the cooling tower; and
addition of electrolytic solution in the recirculated water.

19. The method of claim 16, further comprising stopping the electrolyzing of at least the portion of the recirculated water when the ORP level of the recirculated water is at or is greater than the predetermined value.

20. The method of claim 16, wherein the recirculated water is the electrolytic medium used for electrolyzing.
